(19) United States
(12) Patent Application Publication
(10) Pub. No.: US 2013/0163037 A1
(43) Pub. Date: Jun. 27, 2013

(54) JOB-PROCESSING APPARATUS AND A JOB PROCESSING METHOD

(71) Applicant: Karsten Huster, Bad Iburg (DE)

(72) Inventor: Karsten Huster, Bad Iburg (DE)

(73) Assignee: CANON EUROPA N.V., Amstelveen (NL)

(21) Appl. No.: 13/583,784

(22) PCT Filed: Mar. 11, 2011
(86) PCT No.: PCT/EP2011/053721

§ 371 Date: Mar. 12, 2013

(30) Foreign Application Priority Data
Mar. 11, 2010 (GB) 1004006.1

(51) Int. Cl. G06F 3/12

(52) U.S. Cl. CPC G06F 3/1237
USPC 358/1.15

(57) ABSTRACT

A job-processing method route a print job to one of a plurality of printers in a job-processing apparatus. Each printer has a low-power state and a powered-up state. The method comprises: determining a destination printer from print data included in the print job; determining whether or not the destination printer is in the low-power state; if the destination printer is in the low-power state, selecting at least one alternative printer; determining the state of the at least one alternative printer; and, if the alternative printer is in the powered-up state, re-routing the print job from the destination printer to the alternative printer for printing.

### BACKGROUND OF THE INVENTION

### Description of the Related Art

The present invention relates to a job-processing apparatus and a job-processing method.

In an office environment, it is common to install a print server for storing and releasing print jobs to printers. In addition to directing print jobs from the clients to appropriate printers, the functionality of the printer server may be extended for other uses. For example, it is known to cause the printer server to check the identity of a user accessing a printer before allowing the user to print to the printer. Further, it is known to for the printer server to keep a record of print jobs printed by authenticated users. Keeping such ‘accounts’ of the print jobs printed allows print statistics for a system to be recorded and analysed.

When selling or upgrading print systems it is useful to be able to look at the performance of an existing print system. By monitoring use of an existing print system it is possible to make more informed decisions about how a new system should be configured optimally to meet user's needs.

It is an object of the present invention to provide enhanced print server functionality.

### SUMMARY OF THE INVENTION

According to a first aspect of the present invention there is provided a job-processing method for routing a print job to one of a plurality of printers in a job-processing apparatus, each of which printers has a low-power state, and a powered-up state, the method comprising: determining a destination printer from print data included in the print job; determining whether or not the destination printer is in low-power state; if the destination printer is in the low-power state, selecting at least one alternative printer; determining the state of the at east one alternative printer; and, if the alternative printer is in the powered-up state, re-routing the print job from the destination printer to the alternative printer for printing.

Preferably the job-processing method is carried out in the job-processing apparatus during user configured time periods.

Preferably the alternative printer is selected based on whether or not the alternative printer is a member of a group of printers to which the destination printer belongs. In such a case, the group of printers may correspond to at least one of: a group of printers that are geographically proximate to each other, a group of printers that either can or cannot print in colour, a group of printers with a similar per page printing cost, and a group of printers that have similar power consumption and/or ink-usage characteristics.

The job-processing method may comprise the step of requesting permission from a source of the print job to re-route the print job before re-routing the print job to the alternative printer.

According to a second aspect of the present invention there is provided a job-processing apparatus comprising a plurality of printers, each of which printers has a low-power state, and a powered-up state, the apparatus comprising: a processor for: determining a destination printer from print data included in a print job to be printed in the job-processing apparatus; determining whether or not the destination printer is in low-power state; if the destination printer is in the low-power state, selecting at least one alternative printer; determining the state of the at least one alternative printer; and, if the alternative printer is in the powered-up state, causing the print job to be re-routed from the destination printer to the alternative printer for printing.

There may be provided a computer program that, when executed by a job-processing apparatus, causes the job processing apparatus to perform a method according to the first aspect of the present invention. The program may be stored on a computer-readable storage medium.

According to a third aspect of the present invention there is provided a method of configuring settings for a plurality of: devices comprising: selecting a plurality of devices whose settings are to be configured; selecting a template device the settings of which are to be used for configuring the settings of the plurality of devices; automatically changing the settings of the plurality of devices to correspond to the settings of the template device.

The method may further comprise selecting one or more of a plurality of settings of a device that are configurable, and only the selected one or more settings of the plurality of printers may be changed to correspond to the settings of the template device.

In some embodiments the devices are printers.

In some embodiments the plurality of devices are selected from a list of devices, which list of devices correspond to at least one of: a plurality of devices configured on a server, a plurality of devices having a corresponding group parameter, a plurality of devices having corresponding or similar serial numbers, a plurality of devices having the same assigned names.

A program for configuring settings for a plurality of devices may be provided that, when executed on a processor, causes the processor to perform a method according to the third aspect of the present invention.

According to a further aspect of the present invention there is provided a method of checking workflow data which defines a workflow, the workflow data being formed of data concerning a plurality of workflow elements and data concerning workflow connectors, the data concerning workflow elements including data concerning a plurality of different types of workflow element, a first type of workflow element being a type that should have none or more succeeding workflow elements and no preceding workflow elements and a second type of workflow element being a type that should have none or more preceding workflow elements and no succeeding workflow elements, the method comprising checking whether or not the workflow data meets at least one of the following conditions: a) each workflow element is connected to each other workflow element via one or more workflow connectors, b) each workflow connector connects at least one workflow element to at least one other workflow element, c) each workflow element of the first type has no preceding workflow elements, and d) each workflow element of the second type has no succeeding workflow elements; and the method comprising displaying an error message if checking step finds that the at least one condition is not met.

### BRIEF DESCRIPTION OF THE DRAWINGS

FIG. 1 shows a job-processing apparatus embodying the present invention;

FIG. 2 shows a hardware configuration of a client and a print server;

FIG. 3 shows a hardware configuration of a printer;

FIG. 4 shows a screen for listing configured printers;

FIG. 5 shows a screen of a printer configuration wizard;

FIG. 6 is a flow chart showing steps performed by the printer configuration wizard for bulk configuration of printers;

FIG. 7 shows a further screen of: the printer configuration wizard;

FIG. 8 shows a further screen of the printer configuration wizard;

FIG. 9 shows a further screen of the printer configuration wizard;

FIG. 10 is a flowchart showing steps for printing at the client;

FIG. 11 is a flowchart showing steps for processing a print job at the print server;

FIG. 12 shows a workflow;

FIG. 13 is a screenshot of a workflow designer;

FIG. 14 shows more detail of the workflow designer;

FIG. 15 is a flowchart showing steps in a ‘green’ workflow;

FIG. 16 shows a job-processing apparatus according to a second embodiment of the present invention;

FIG. 17 shows a screen for configuring a job-identification service; and

FIG. 18 snows steps performed by a job-identification service.

### DESCRIPTION OF THE EMBODIMENTS

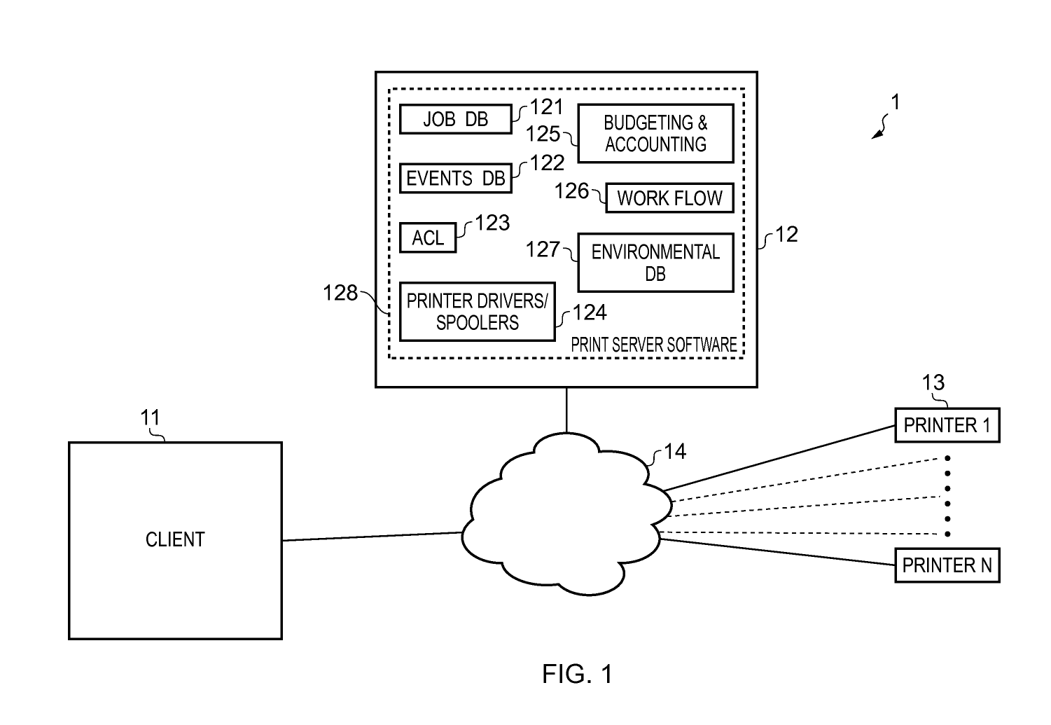

The job-processing apparatus 1, shown in FIG. 1, comprises a client 11, a print server 12, and N printers (where N is any positive integer) 13 connected to each other via a network 14.

The print server 12 includes print server software 128 including the following components: a job database 121, an events database 122, access control lists 123, one or more printer drivers and/or spoolers 124 for the printers 13, a budgeting and accounting module 125, a workflow module 126, and an environmental database 127. The functions of these components will be described in detail further below.

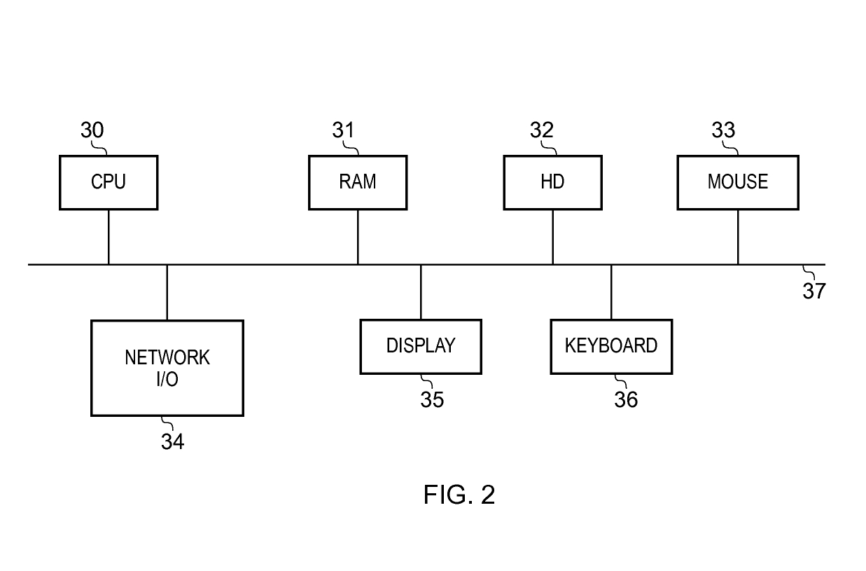

The hardware configuration of the client 11 and the print server 12 is similar and is shown schematically in FIG. 2. The hardware includes a central processing unit (CPU) 30 such as a processor manufactured by AMD® or Intel®, Random Access Memory that acts as a storage area for the CPU 30, a hard disk drive 32, a pointing device such as a mouse 33, a network I/O 34 that allows the client or print server to communicate over the network, a display 35 such as a Liquid Crystal Display (LCD) for displaying information to a user, and a keyboard 36. Each of these components is connected to each other via a bus 37. This hardware configuration is only illustrative and may be supplemented by additional hardware commonly known in the art (such as graphics cards, wireless communication devices etc.).

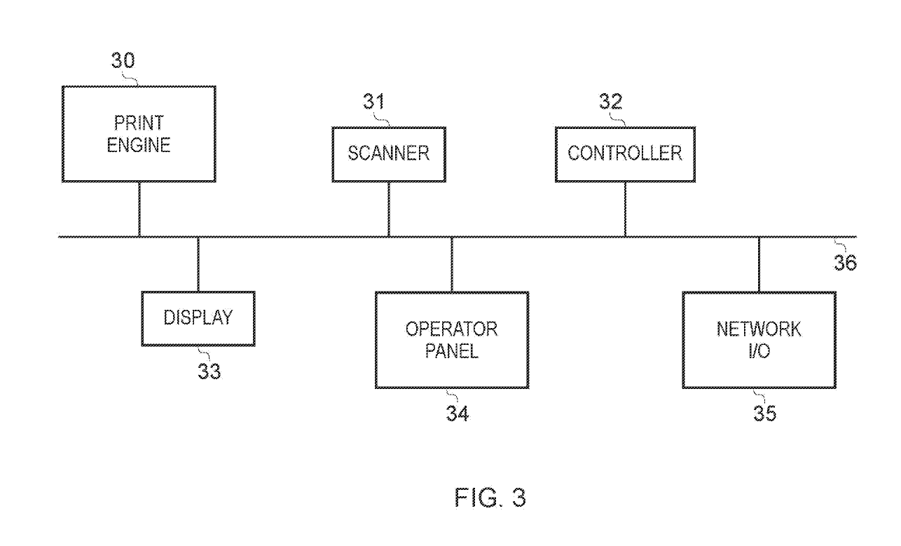

FIG. 3 shows the hardware configuration of one of the printers 13. The printer 13 may be any type of printer, such as a multi-function peripheral (MFP), single function printer (SFP), ink-let printer, laser printer, etc. However, for illustration, MFPs 13 will be described here. Each MFP 13 comprises a print engine 30, which consists of the hardware for printing onto a display medium such as paper, acetate, or some other display medium; a scanner 31; a controller 32, which controls operation of the various components of the MFP 13; a display panel 33, which is a touch screen display for displaying information to a user and for receiving commands by a user's touch; an operator panel 34, which includes buttons and/or other input devices for receiving user instructions; and a network. I/O 35 that allows the MFP 13 to communicate over the network 14. The components of the MFP 13 are connected to each other via a bus 36. Optionally, the MFP 13 may include additional hardware of the types known in the art.

### Bulk Printer Configuration

When the job-processing apparatus 1 is setup, the print server software 128 needs to be configured. The steps for configuring the print server software 128 may include, but are not limited to, installing the printer drivers 124 for the printers, entering license information for the print server software 128, configuring information in the budgeting and accounting module 125 (cost centres etc.), setting up the ACts 123, configuring workflows in the workflow module 126 etc. Many of these steps are known in the art and are not described in detail here. Among the steps that need to be performed is configuration of printers 13 in the print server software 128 so that the software installed on the print server 12 can make use of the printers 13 to which the print server 12 may print. The steps are performed at the print server 12.

If the number of printers, N, is large, configuring printers can be a time consuming process. For each printer 13, it is typically necessary to enter at least the following basic information:
a. Mac address (for networked printers)
b. IP address (for networked printers)
c. Serial number
d. Manufacturer name
e. Device model name.

It is further desirable to configure some or more of the following further information, which is used by the print management software 128. This further information could include a wide variety of parameters, but examples include:
a. Details of cost centres to which prints from the printer 13 are to be charged
b. Details of a workflow to be applied to jobs originating from the printer 13
c. Details of a price profile associated with printing from the printer 13
d. Access control settings
e. Details of a group to which the printer 13 belongs
f. Details of ‘device agents’ associated with the printer 13. A device agent is a program or code portion which is used to take advantage of particular features provided with a printer 13. For example, if the print has a copy counter, a copy counter device agent may retrieve copy counts from the printer 13 for the printer server software 128. Other device agents might be used for, for example, device status monitoring.

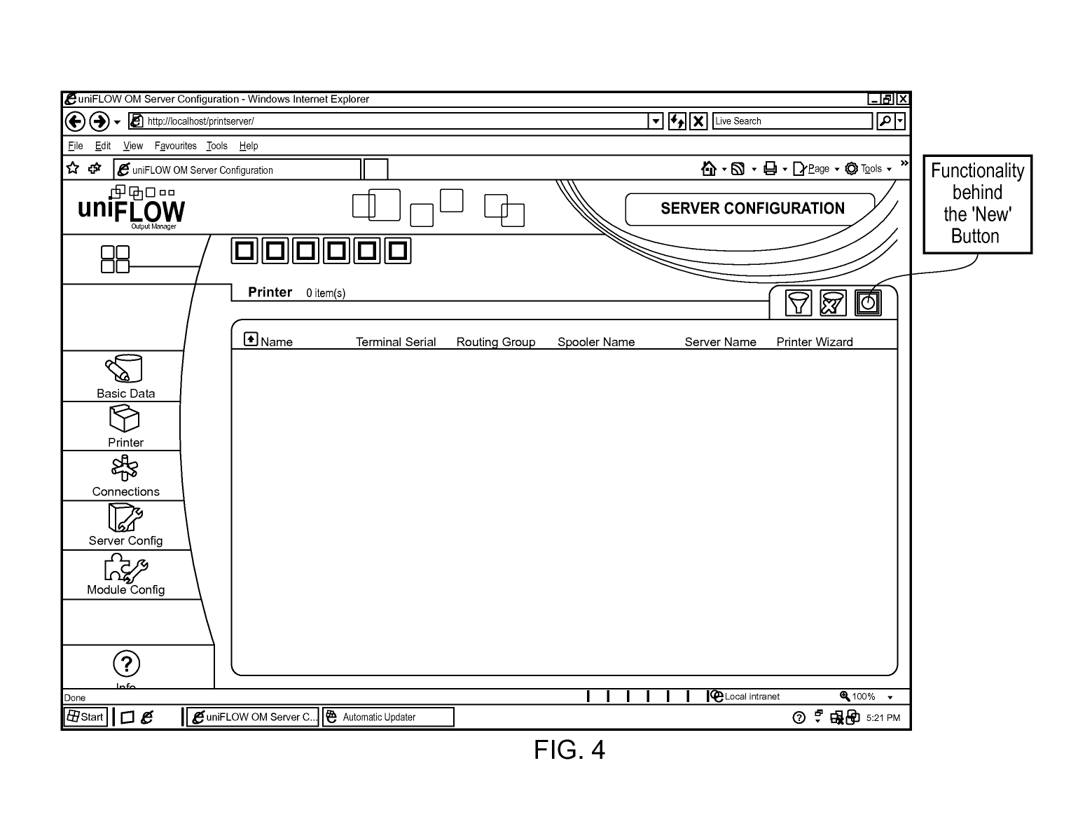

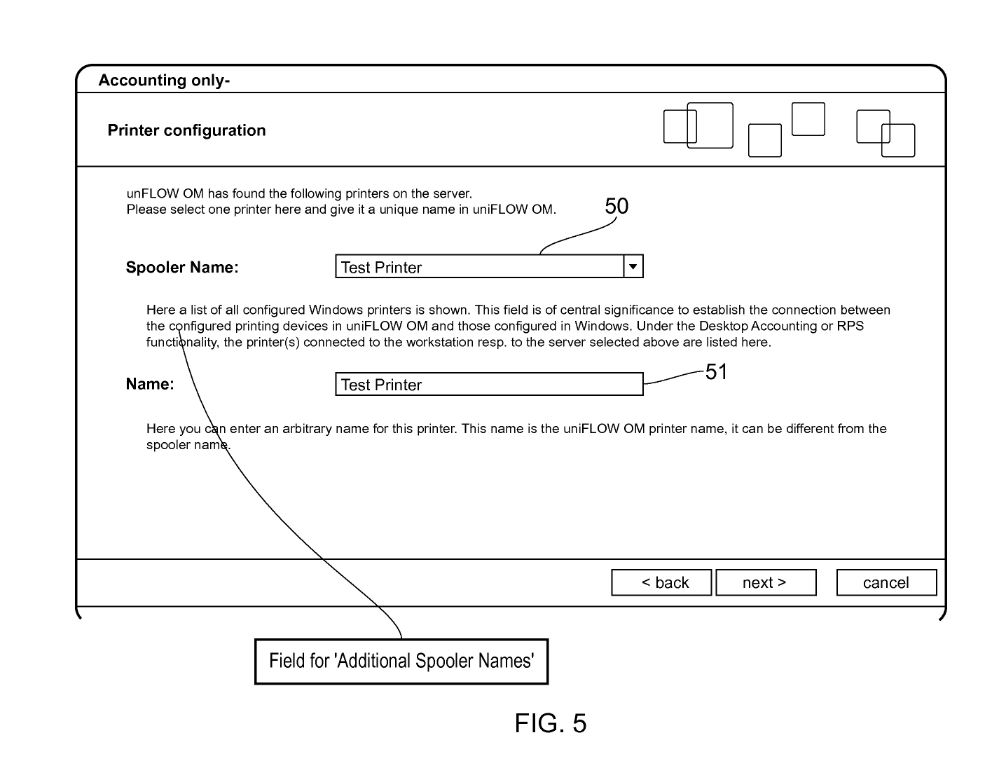

In order to allow the configuration of new printers, the print server software 128 includes a wizard for printer configuration. FIG. 4 shows a screen of the software on which a list of configured printers may be displayed. The screen shown in FIG. 4 does not include any configured printers. A new printer may be configured by selecting button indicated by the line and box “Functionality behind the new button”. If the new printer button is selected, the user is presented with an option to choose between configuring a single new printer, and configuring multiple new printers. If the user elects to configure a single printer, the print server software 128 detects printers as described in more detail below and displays a selection screen to give the user a choice of the detected printers so that the user can select the printer to configure. This selection screen is shown in FIG. 5 and includes a drop-down menu 50, which allows a user to select a detected printer 13 by the name of its associated spooler, and provides a field 51 for a user to enter text to name the printer for the purposes of use within the print server software. The user is then provided with one or more screens in which to enter the further information discussed above (cost centre, workflow, price profile, etc.).

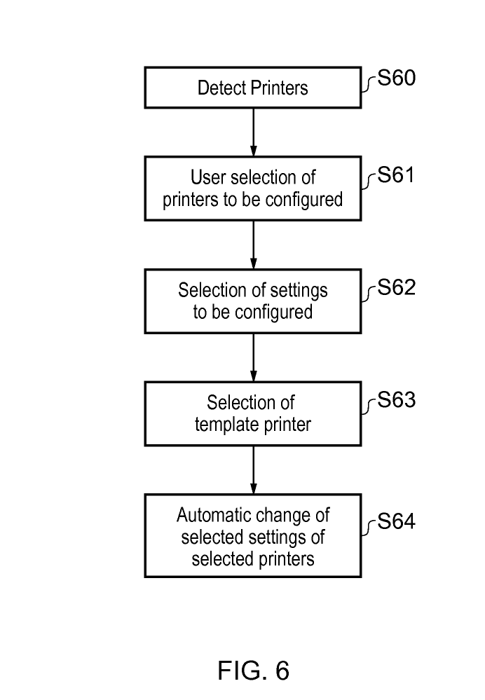

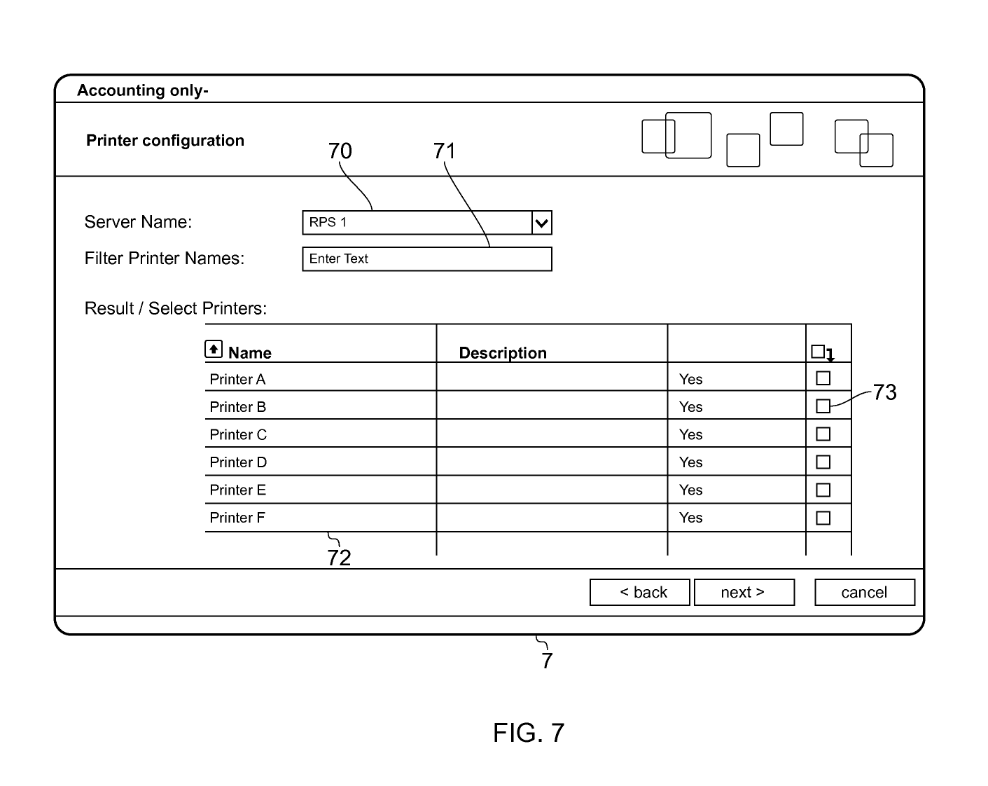

FIG. 6 is a flow chart showing the steps performed in a case that the user chooses to configure multiple printers in the wizard. In step 860, the print server software detects printers as will be described in more detail below. In step S61, printer server 12 displays a printer selection screen 7 (FIG. 7). The printer selection screen includes a printer display field 72, which shows multiple printers (Printer A, Printer B, Printer C, etc) detected on a remote print server ‘RPS 1’. A drop-down menu 70 allows a user to select different print servers so that the printer display field 72 displays spoolers located on different print servers. A field 71 allows a text to be entered for filtering the printers so that only those printers whose names include the entered text are displayed in the printer display field 72. On the right-hand side of the printer display field 72 there are check boxes 73 corresponding to the printers to allow a user to select printers to be configured.

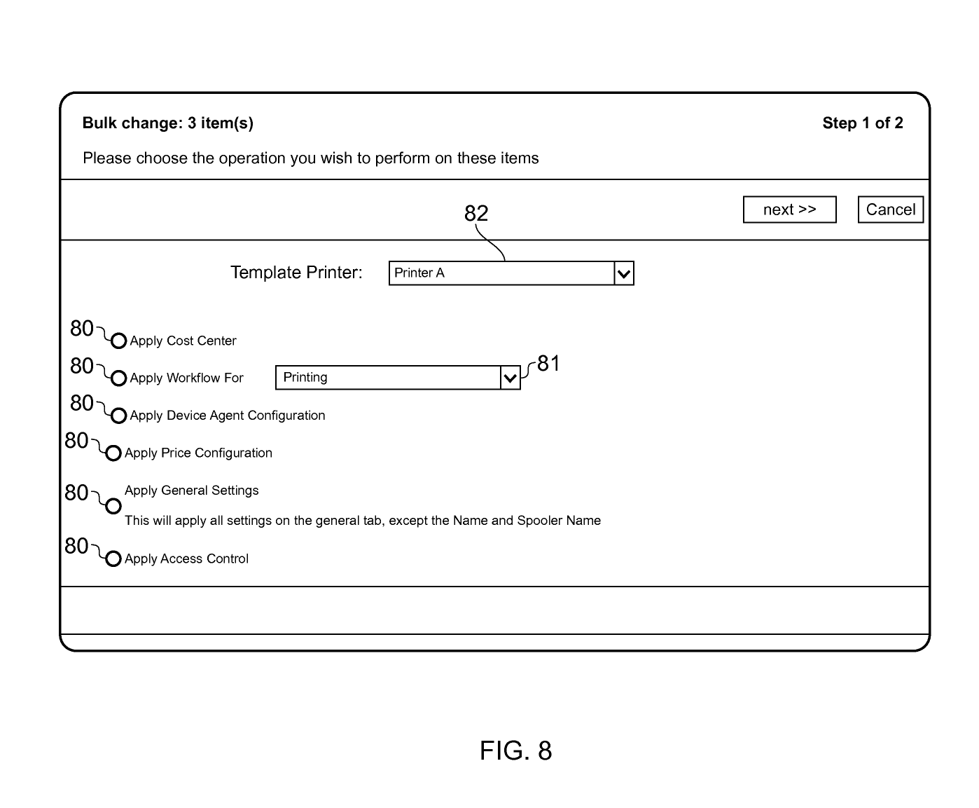

After selecting the printers to be configured, the user selects a “next” button and identifies the settings of the printers to be configured (S61 in FIG. 6). A settings screen for selecting the settings to be configured is shown in FIG. 8. The settings screen includes a list of parameters that can be configured for the selected printers, with radio buttons 80 next to each parameter. The user can select the radio buttons of the parameters to be configured. One of the options “apply workflow for” has a drop-down menu 81 next to it. As will explained in more detail later, a workflow may be assigned to a printer for different functions such as printing, scanning, faxing, etc. Accordingly, the drop-down menu 81 allows the user to select which workflow configuration information is to be configured for the selected printers 13.

In step S63 of FIG. 6, the user selects a template printer from which the configuration information is to be copied. This selection is made by selecting a template printer from the drop-down menu 82 in FIG. 8.

After the template printer has been selected, the print server software automatically configures the printers selected in step S61. Only those settings of the selected printers that were selected in step S62 are changed to match the setting's of the template printer selected in step S63. In this way, the wizard allows easy selection and configuration of multiple printers without the need to repeatedly enter the same data.

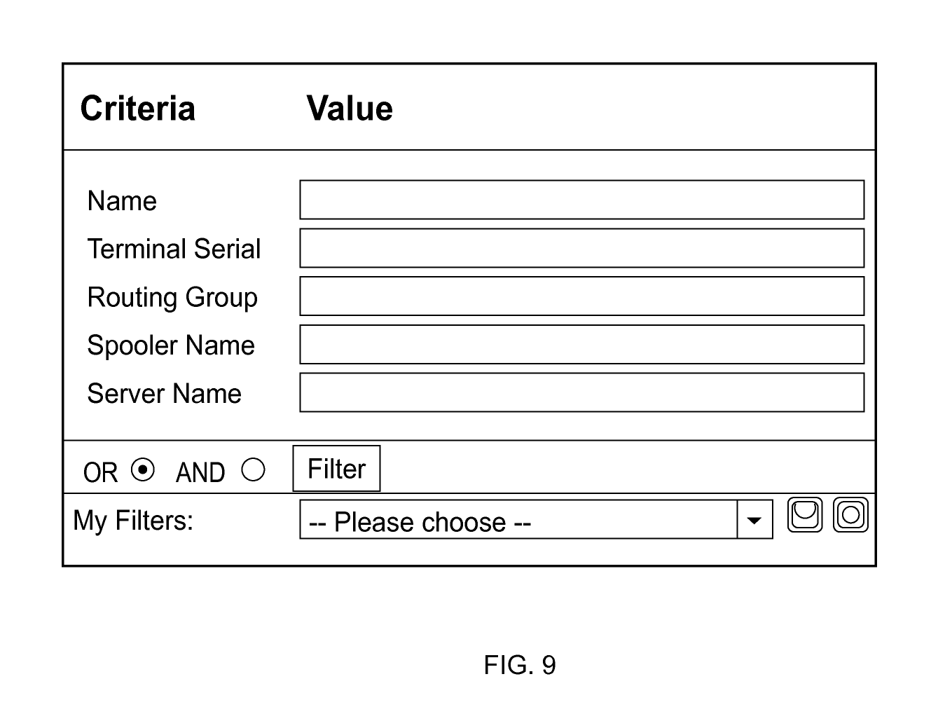

In an alternative embodiment, the filter associated with the text field 71 in FIG. 7 may be enhanced to allow more powerful filtering. FIG. 9 shows an example of a screen of such an enhanced filter facility. The screen shown in FIG. 9 allows a user to specify a combination of the printer name, printer serial number, a routing group parameter, a spooler name, and a server name in order to identify printers that may be selected for bulk configuration.

In a further embodiment, the wizard may include a screen to allow a user to specify whether the bulk configuration is to be performed once, or performed repeatedly as a task according to a schedule. For example, in an office environment in which many printers of a single type are used with a similar configuration, the bulk configuration task could be performed daily so that any new printer installed on the network is automatically configured within a day of installation.

As mentioned above, step S60 requires the print server software 128 to automatically detect printers. This detection may be performed according to one or more of the following methods. If printer drivers for the printers are already installed on the print server 12 or a user-designated remote print server, the printers may be discovered by searching for their corresponding job spoolers. For example, if the print server is a Windows® print server, the printers can be identified from operating system and the basic information (IP address, serial number etc.) obtained. Accordingly, the wizard can provide a screen, such as FIG. 7, to allow the user to specify which servers the user wishes the print server software 128 to search on, printer spoolers on those servers can be detected, and details of the corresponding printers displayed for user selection.

A second method involves detecting printers directly from the network. In this case, the user is prompted to enter a network IP address range, after which the print server software 128 queries each address within the specified range in order to detect printers installed at the specified IP addresses. Similar to the bulk configuration steps, this task of querying IP addresses within a range may be performed once, or as a periodic task according to a schedule.

When a user is using the printer configuration wizard and device discovery is in progress, a progress bar is shown to keep the user informed of the progress of the discovery. Further, when the discovery is completed, the user is presented with a list of discovered printers for approval before continuing with the configuration process.

The print server software 128 also includes a bulk change wizard in which printers that are already configured in the print server software 128 can be reconfigured according to a user's wishes. The bulk change wizard performs steps S61 to S64 of the process shown in FIG. 6, allowing a user to select existing configured printers (equivalent to S61), select the settings to be changed (equivalent to S62), select a template printer (the same as S63), and automatically change the selected settings on the selected printers (the same as S64).

It should be noted that the bulk configuration or bulk change of printer settings should not include overwriting the IP address, or any device specific settings in a printer record as these necessarily vary from printer to printer.

### Workflows

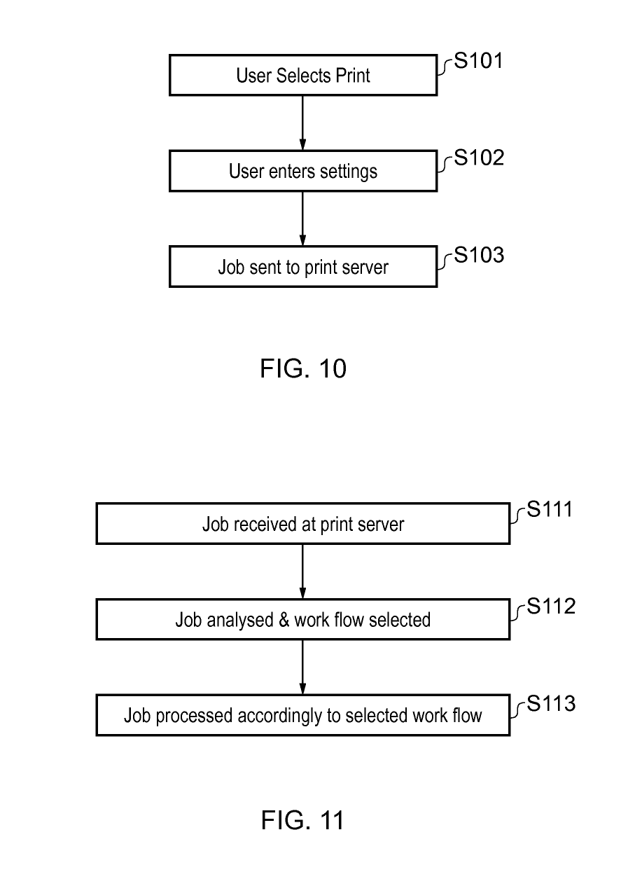

Once the job-processing apparatus 1 is configured, the use can perform the steps shown in FIG. 10 to print from a client 11 to a printer 13. In S101, the user selects a print option from within whichever software application (Word®, Adobe Acrobat® etc.) on the client 11 that he or she is using. The print option opens up a printer driver installed on the client 11 and allows the user to enter print settings S102 such as simplex/duplex printing, colour/monochrome printing, stapling, etc. After making appropriate settings, the user sends, S103, the print job to the print server 12 by selecting a “print” button or by a similar operation.

FIG. 11 shows the general steps performed by the print server software when the print job sent from the client 11 is received at the print server 12. In step S111, the print job is received at the print server. In step S112, the print job is stored in the job database 121, analysed, and an appropriate workflow for the print job is selected. This step will be described in more detail below. In step S113, the print job is processed according to the workflow determined in S112.

The above steps are described for a print job, however similar steps are performed for a scan job received from a printer 13, or any other type of job that the job processing apparatus can process (email job, etc.).

The relevant workflow is selected in step S112 based on the ‘workflow roles’ of workflows assigned to the printers and based on global workflows. The print server software 128 is configured allow following types of workflow role to be assigned to a workflow: print workflow, scan workflow, document management workflow, email workflow, status workflow, and error workflow. A print workflow is configured to perform operations on a print job including sending it to at least one printer 13 for printing. A scan work flow is configured to process a job that originates from a scanning operation at a printer 13. A document management workflow is configured to control submission of a job to a document management system (not shown) and is initiated from the client 11. An email workflow is configured to control processing of an email either being sent from the client 11 or being received at an email server (not shown) and distributed to the client 11. Status workflows will be described later in connection with device statistics. An error workflow is created to deal with jobs that encounter an error in some other workflow. The error workflow may inform a user or administrator that there has been a problem in a workflow and that a job could not be processed.

As mentioned above, workflows are assigned to particular printers for particular roles. Additionally global workflows are defined for use by the print server software as a default. Thus, if there is no workflow attached to a printer for a particular role, the print software uses a global workflow for that particular role instead. By way of example, if a print job is sent to a printer 13, the print server software 128 checks to see if a print workflow is defined for that printer 13. If no workflow is defined, the print server software 13 looks for a global print workflow to user to process the print job.

Scan, document management, and email workflows work slightly differently from print workflows in that a user selects the workflow to be performed at the time that the job is initiated. Thus, in step S112, the workflow is selected by the print server 12 based on workflow information in the job received from the printer 13 or client 11. The workflows may also have associated access control lists (ACL) 113, which define which users may use the workflow. This means that not every user may be able to select every workflow at a printer 13 or client 11. In a case of an ACL 113 associated with a print workflow, a user may receive a message that he or she is not allowed to print to a particular printer 13, if the user sends a print job to the printer 13 that is inconsistent with the relevant print workflow ACL 113.

Each workflow is made up of workflow elements which have the following properties: a name, an arbitrary property field (for general use), identification of one or more successor components, and an identification of an error workflow to be executed in case there is an error in the workflow. The workflows (consisting of a plurality of workflow elements linked together) may be imported and exported from the print server software as XML data allowing workflows to be copied between different job-processing apparatuses. The XML data includes all the configuration settings necessary to perform the workflow.

As mentioned above in connection with bulk printer configuration, workflows can be assigned to multiple printers 13 by configuring the workflow on a template printer 13 and using the bulk change or bulk configuration wizard to copy the workflow settings to other printers 13.

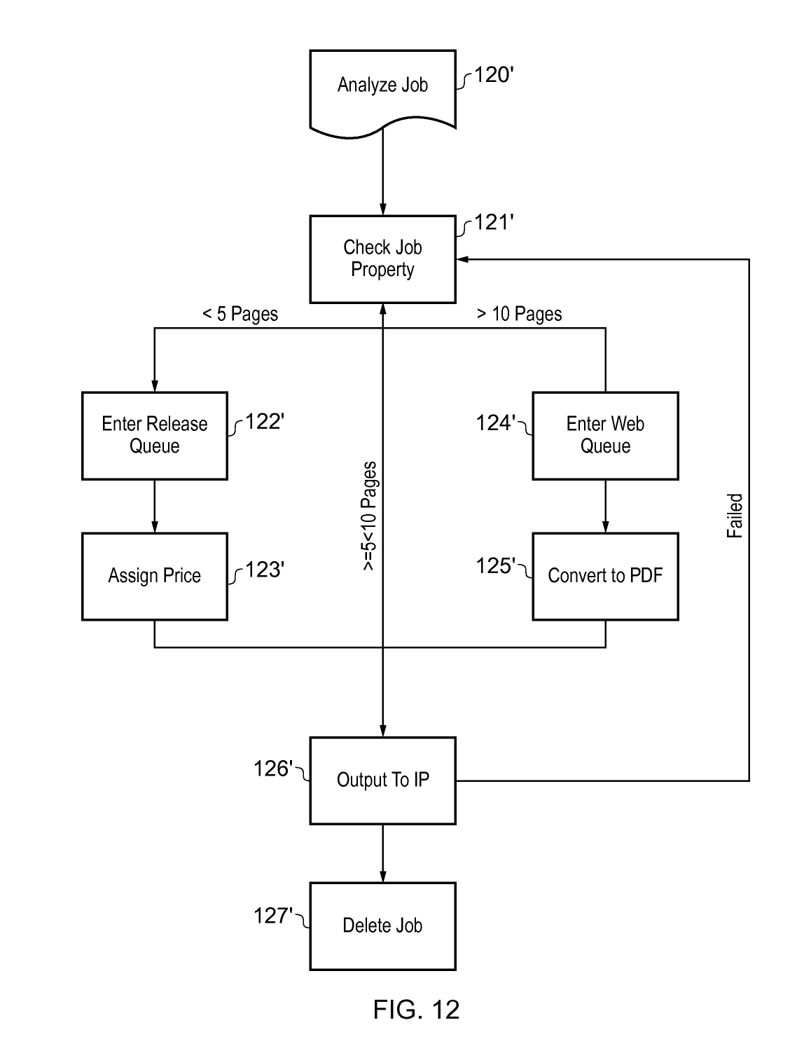

The workflow module 126 includes a workflow designer to allow a user to configure a workflow for a particular printer 13, or as a global workflow. The workflow module 126 provides a graphical user interface in order to allow a user to easily configure different workflow. A sample workflow is shown in FIG. 12 by way of example only. Of course many different workflows could be designed using the workflow module 126.

The workflow shown in FIG. 12 is a print workflow. A first workflow element 120 is named ‘Analyse Job’ and corresponds to the receipt of a print job from the client 11 at the print server 12 and determination of the appropriate workflow for the print job. Once the workflow for the print job has been determined to be the workflow shown in FIG. 12, the process moves to the successor workflow element. The first workflow element 120′ has a single successor workflow element 121′, named ‘Check Job Property’. The check job property workflow element 121′ corresponds to a step of looking at the number of pages of the received print job. At this stage the workflow splits and the check job property workflow element has three successor workflow elements selected according to the number of pages of the received print job. If the result of checking the number of pages of the print job reveals that the job has fewer than five pages, the next workflow element is a ‘Enter Release Queue’ workflow element 122′. The enter release-queue workflow element 122′ sends the received print data to a release queue on the print server. The release queue sends queued print data from the release queue to a user-designated printer 13 upon receipt of a request from the printer 13. When the print job is requested from the printer 13, the enter release queue step is completed. The successor workflow element for the enter release queue workflow element 122′ is an ‘Assign Price’ workflow element 123′. The assign price workflow element 123′ calculates a cost of printing the print job based on the determined number of pages and a price profile associated with the printer 13 from which the print job has been requested. The calculated cost is sent to the requesting printer 13 and displayed to the user.

If the check job property workflow element 121′ finds that the print job has between 5 and 10 pages, the print job successor workflow element is ‘OutputJob to IP’ workflow element 126′ which will be described below.

If the check job property workflow element 121′ finds that the print job has more than 10 pages, the successor workflow element is the ‘Enter Web Queue’ workflow element 124′. The enter web queue workflow element 124′ sends the print job to a web queue, which is a queue for print jobs submitted via the network 14, which could be the internet, a corporate intranet, or some other network depending on the circumstances. When the print job reaches the end of the web queue, the workflow moves on to the ‘convert to PDF’ workflow element 125′. The convert to PDF workflow element 125′ converts the print job into PDF (Portable Document Format).

The successor workflow element for the assign price workflow element 123′, check job property workflow element 121′ (if the job has five to ten pages), and the convert to PDF workflow element 125′ is the ‘Output Job to IP’ workflow element 126′. The output job to IP workflow element 126′ sends the print job to the appropriate printer 13 for printing. If the sending of the print job fails, the workflow returns to the check job property workflow element 121′. Otherwise, if the sending is successful, the workflow proceeds to the ‘Delete Job’ workflow element 127′, which corresponds to deleting the print job from the job database 121′ where the print job is stored during processing.

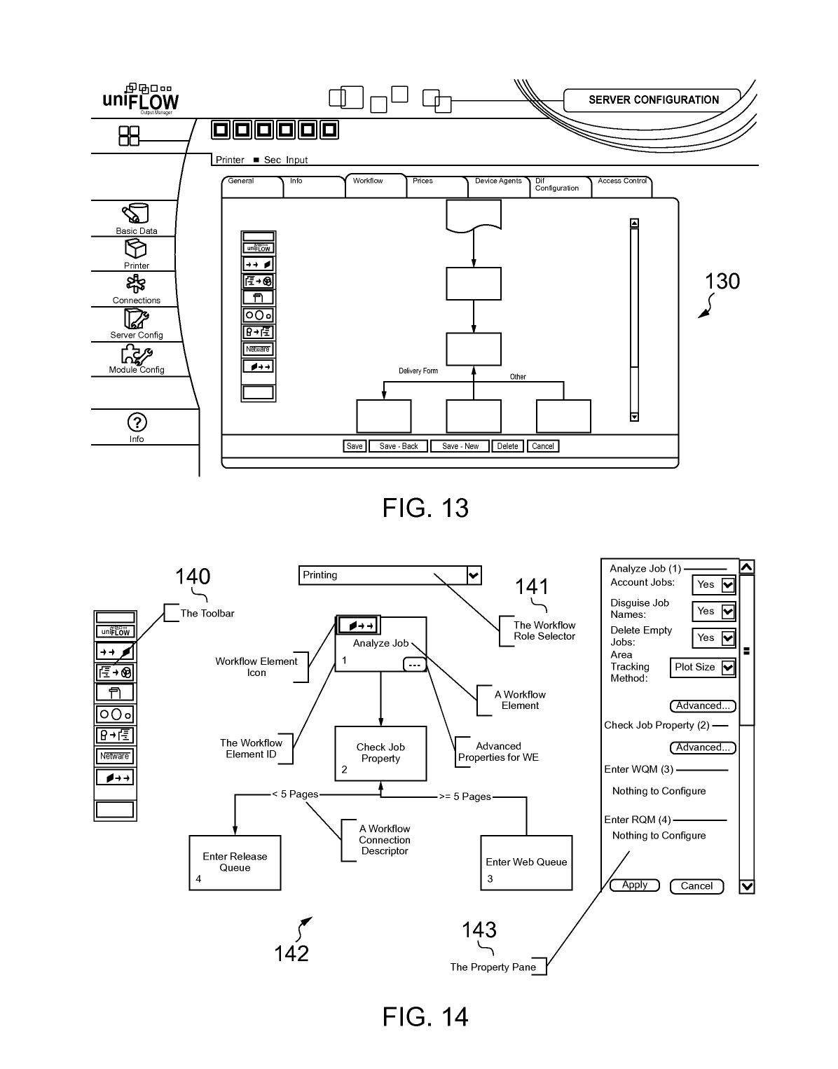

The graphical user interface of the workflow designer is shown in FIG. 13. The workflow designer is provided on a tab of a printer properties screen 130. The printer properties tabs include a ‘General’ tab for general printer information, an ‘Info’ tab for further printer information, a ‘Workflow’ tab including the workflow designer, a ‘Prices’ tab for configuring printer price profile information, a ‘Device Agents’ tab for configuring device agents associated with the printer, a ‘DIF Configuration’ tab that shows information from the printers corresponding DIF file, and an ‘Access Control’ tab that is operable to set user access properties for the printer.

FIG. 14 shows the workflow designer in more detail. The workflow designer consists generally of a toolbar 140, a workflow role selector 141, a work area 142, and a property pane 143. The toolbar 140 includes a number of tools for adding workflow elements and connecting workflow elements. Workflow elements can be dragged and dropped from the toolbar 140 into the work area 142. The workflow role selector 141 allows the role (printing, scanning, document management, etc) to be selected by a drop-down menu. The property pane shows information relating to the workflow element being worked on. In FIG. 14, the ‘Analyse Job’ workflow element is being configured.

Once a user has designed a workflow, the workflow designer performs basic checks to see if the workflow includes any errors. The workflow checks include, but are not limited to, checking to see if all the workflow elements are connected appropriately and locking for open workflow element connectors. Some workflow elements in a workflow may be terminal workflow elements that shouldn't have successor workflow elements, such as for example a workflow element that sends a job to another workflow. Accordingly, the workflow designer can check to see whether such a terminal workflow element has any successor workflow element and display an error message if it does. A similar check may be performed for workflow elements that either start a workflow (need to have no preceding workflow elements) or which need to have either or both a preceding and succeeding workflow element. Similarly, a workflow connector, depicted as a line with an arrow in FIG. 12, should always lead to another workflow element. Accordingly, in a case that there is a work flow connector that is not connected to another workflow element an error message is displayed. Similarly, any ‘orphaned’ workflow elements that have been placed in the work area 142 but not connected to the remainder of the workflow prompt an error message because they form no useful part of the workflow.

The workflow designer is provided on tabs of a printer configuration page in FIG. 13. However, another page of the print server software also includes the workflow designer to allow configuration of global workflows.

### Device Statistics

The printers 13 typically operate in one of several different states: a busy state in which the printer is printing; an idle state in which the printer is ready to print, but not printing; and a sleep state in which the printer is in a power saving mode; an error state in which the printer is inoperable; etc.

Each of the printers 13 is configured to send a notification to the print server software when it changes between the states mentioned above. The notifications received from the printers 13 are stored in the events database 122. The records of the changes between states (status data) in the event database 122 allow the print server software to generate and display various statistics such as printer uptime, mean time for resolution of errors, etc.

In addition to being able to display useful statistics, the events database allows various additional workflows to be configured. In particular, a status workflow may be configured which sends notifications in dependence upon a change of status of a printer. The status workflow can be configured either as a global workflow or in association with a printer. Whilst the status workflow can be flexibly configured according to a user's wishes, some options in a status workflow will now be described by way of example.

A status workflow may be configured in association with a printer 13 so that when a notification is received by the print server software 128 that a printer 13 has entered into an error state, the print server software 128 sends an appropriate notification to an administrator. The notification may be sent by email or by completing a form in an internal IT maintenance ticketing system (not shown). Further the workflow may be configured to include time based conditions to allow an error to be escalated. For example, the workflow may indicate that when the notification that the printer has entered into an error state is received a message is sent to a first person, and, after the error state has persisted for a period set in the workflow, a second message is then sent to the same or a different person. In this way, persistent printer errors can be escalated or an administrator reminded if an error continues.

A further use for the data recorded in the events database 122 is to generate information about the energy consumption of the printers 13. The environmental database 127 includes data about the energy consumption of the printers 13 in their different states. Accordingly, by multiplying the energy consumption rate of the printers recorded in the environmental database 127 by the time that the printer spent in the state, which data is recorded in the events database 122, energy use of a particular printer 13 may be calculated.

In a further embodiment of the present invention the data in the events database is supplemented information concerning the number of pages printed by each printer. With this additional information, if the energy consumption per page printed is stored in the environmental database 127, the energy consumption when the printer is in the busy state can be more accurately estimated by multiplying the number of copies printed by the energy per sheet printed. In further embodiments, the calculated energy consumption may be further refined by taking into account information from an energy meter built in to the printers 13.

Over time the events database will receive a large number of event notifications from the printers 13. In order to prevent excessive growth of the size of the events database 122, the events database 122 may be periodically purged by a database management task. The database management task may either transfer excess data to another storage area (archiving the data) or delete the excess data (for example deleting data that is more than one year old).

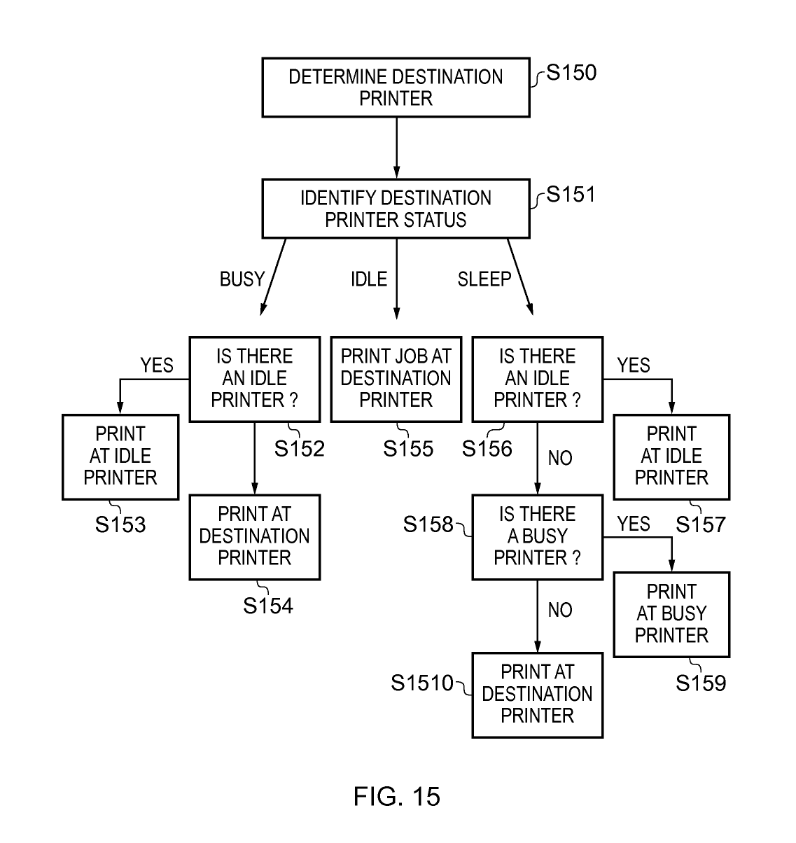

A further use of the data in each of the environmental database 127 and events database 122, and the workflow designer is in the creation of ‘green’ workflows. An example of the steps of a ‘green’ workflow is shown in FIG. 15. The ‘green’ workflow can be configured using the workflow designer although this is not illustrated here. As with the other workflows, the steps of the workflow are performed at the print server 12. In step S150 an original destination printer selected by a user is determined from the received print job properties. Once the destination printer has been identified, in step S151 the status of the destination printer is determined from the events database 122. If the device status is determined to be ‘busy’, the workflow proceeds to step S152 to determine whether or not there is an alternative printer that is idle. If there is an alternative printer that is idle, the print job is re-routed to the idle printer. If there is no alternative printer that is idle, the print job is queued for the destination printer.

If the destination printer is determined to be idle in S151, the print job is forwarded to the destination printer.

If the destination printer is determined to be sleeping in S151, the workflow proceeds to step S156. In step S156 it is determined whether or not there is an alternative printer that is idle. If there is an alternative printer that is idle, the print job is re-routed to the idle printer and printed in step S157. If there is no alternative printer that is idle in S156, then the workflow proceeds to step S158. In S158, it is determined whether or not there is an alternative printer that is busy. If there is an alternative printer that is busy, the print job is re-routed, queued for the alternative printer that is busy, and printed in step S159. If there is no alternative printer that is busy in S158, the print job is sent to the destination printer, which is woken from its sleep state.

The advantage of the ‘green’ workflow described above is that a printer is only woken from a sleep state if it is necessary to do so. This tends to decrease total power consumption of the job-processing apparatus 1 because the energy required to wake a printer from a sleep state is relatively high due to the need to initialize the electronics, heat the fixing elements etc.

If in step S152, S156, or S158 more than one printer is identified as idle or busy, the printer may be selected based on a user preference configured in association with the destination printer 13. That is, for each printer a ranked list of alternative printers may be configured by the user and the print server software 128 may select the highest ranked printer 13 that is busy or idle as specified above.

The workflow shows in FIG. 15 assumes that print server software 128 can identify ‘alternative’ printers. The alternative printers may be identified, by a configured list as mentioned above or, in an alternative embodiment, identified by grouping the printers using the group parameter in the printer record. Printers may be grouped according to one or more different parameters. Examples of the grouping parameters are
a. geographic location
b. colour/monochrome printers
c. Power consumption or other environmental factors such as ink consumption
d. Cost of printing

The configuration of appropriate alternative printers for use in the ‘green’ workflow allows appropriate re-routing to be performed. If the groups of printers that can be used as alternative printers are selected by geographic location it can be ensured that the print job is printed at a printer that is reasonably close to the user. If the groups of printers for use in determining alternative printers are selected by colour/monochrome printers it can be ensured that if a user has selected to print a colour print job, the job can be printed in colour as the user requested. If the groups of printers for use in determining alternative printers are selected by power consumption or other environmental factors it can be ensured that a print job will not be re-routed from a printer with low power/ink consumption to a printer with high power/ink consumption (e.g. re-routing a job from an MFP to an inkjet printer). If the groups of printers for use in determining alternative printers are selected by the cost of printing it can be ensured that a, possibly large, print job is not re-routed from a low-cost printer to an expensive printer (e.g. re-routing a print job from an MFP to an expensive large format printer).

The ‘green’ workflow is likely to be particular effective for conserving energy when the job-processing apparatus is not being used intensively, in which case it is likely that several of the printers 13 are in the sleep state. This is likely to happen in an office installation either early in the morning or late in the evening when many of the employees will have left the office. Accordingly, the ‘green’ workflow may be configured to work only between certain hours of the day (say between 7 pm and 7 am) when it is most likely that printers will be wastefully woken from their sleep states to print one or two jobs before being left idle for a long period of time. During these periods the ‘green’ workflow will serve to direct print jobs to a limited number of idle or busy printers, which will be kept busier thereby reducing the overall, power consumption of the job-processing apparatus. This also avoids using the ‘green’ workflow during busy periods when the workflow is likely to cause congestion on a limited number of printers 13.

A further feature of the ‘green’ workflow is that before re-routing a print job from the destination printer to an alternative printer, the print server software sends notification to the client 11 to allow a user to confirm whether or not the re-routing of the print job is acceptable. The notification may take the form of an email, a pop-up window, or the like at the client 11. The user may confirm approval or disapproval of the re-routing by, for example, clicking on a hyperlink in the received email or selecting an approve or a disapprove button in the pop-up window.

### Second Embodiment

When installing a new job-processing apparatus or upgrading an existing job-processing apparatus it is useful to perform a print audit to collect statistics from the existing job-processing apparatus in order to be able to recommend appropriate new equipment or to allow optimal utilization of existing equipment. A print audit typically takes place over a period of thirty to sixty days during which prints made on a job-processing apparatus are recorded for analysis. Print audits differ from normal print system accounting (i.e. recording printing on a job-processing apparatus for billing purposes) in the following ways:
a. in a print audit it is less important who printed what and more important to identify what was printed where and how;
b. a print audit does not necessarily need to record information about all the printers or users that have been tracked, just the main printing activities that incur the largest costs in the job-processing apparatus;
c. the results of a print audit must be understandable by a customer;
d. a print audit may contain environmental information as well as information about the total cost of printing.

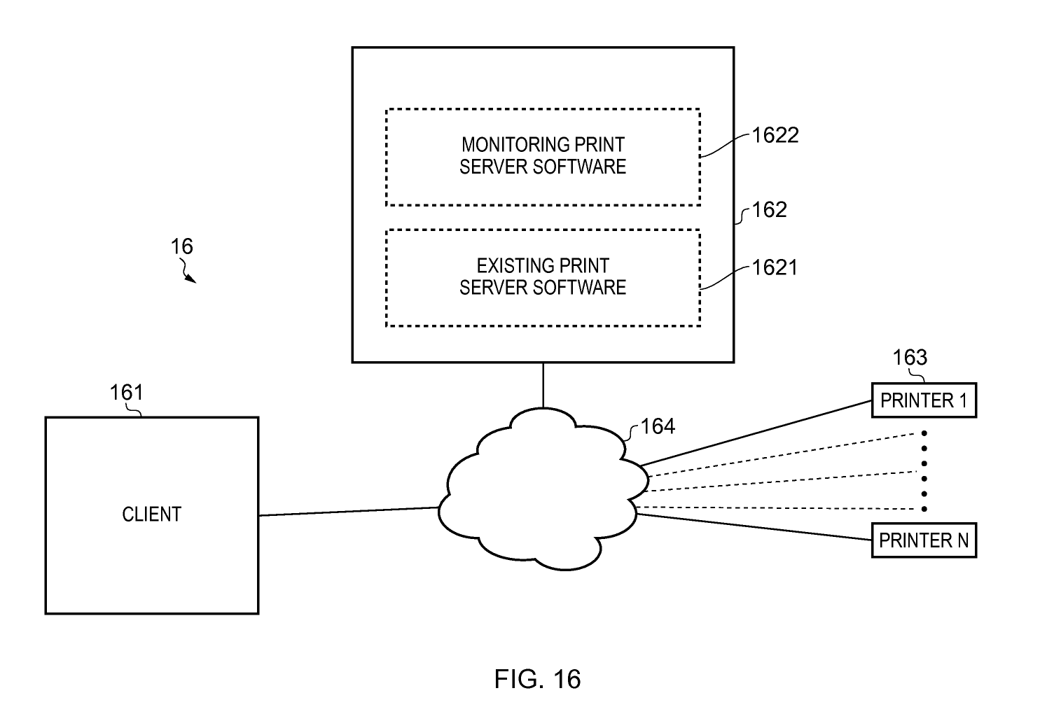

FIG. 16 shows a job-processing apparatus 16 according to the second embodiment of the present invention. The job-processing apparatus is similar to the job-processing apparatus of the first embodiment in that it comprises a client 161, a print server 162, and a number of printers 163 connected to each other via a network 164. The job-processing apparatus differs from that described in connection with the first embodiment in that the print server 162 has existing print server software 1621 and monitoring print server software 1622 installed on it. The existing print server software 1621 is provided to spool and release print jobs to the printers 163, thereby at least providing conventional print serves functionality. The monitoring print server software 1622, embodying the present invention, is installed on the print server 162 to perform a print audit of the job-processing apparatus 16.

A print audit generally consists of three parts: data collection, data validation, and data reporting. In order to collect print data during the audit, the monitoring print server software 1622 needs to be configured to identify the printers 163 in the job-processing apparatus 16 so that the spoolers for the printers 163 can be monitored and printer usage data recorded for analysis. In systems in which there are a large number of printers 163, this poses a similar problem to the bulk printer configuration problem addressed in the first embodiment. Accordingly, printers 163 may be configured in the monitoring print server software 1622 using a wizard as described in the first embodiment in connection with FIGS. 4 to 9.

In addition to automatically detecting printers installed on the print server 162 (or a user-designated remote print server), print and data may be collected from the client 161 to identify any print jobs that are sent directly from the client 161 to the printer 163 without spooling on the print server 162. In order to obtain this information the monitoring print server software 1622 uses Windows® WMI technology to scan the client 161 for its installed printer drivers and to read out a corresponding event log. The event log contains a record of printing activity on the client 161 allowing monitoring of printing at the client without the need to install a monitoring software application on the client.

In order to read the event log on the client 161, it is first necessary for the monitoring print server software 1622 to detect the existence of the client 161. The client 161 (or, more typically, clients) is detected by searching an IP address range entered by a user to the monitoring print server software 1622.

A further piece of information that it is useful to collect during a print audit is the application from which a print job originated. For example, to be able to identify how many print jobs originated from a word processing application, how many from a spreadsheet application, etc. When a print job is printed by a client 161 running Windows®, the print job is allocated a name which sometime includes the name of the originating application. For example, when printing a file named “draft specification” from within Microsoft Word®, the print job might be called ‘Microsoft Word—draft specification.doc’. Accordingly, when the monitoring print server software 1622 identifies a print job printed by the job-processing apparatus 16, the monitoring print server software 1622 can examine the print job name to try to identify the originating software application.

A problem with trying to identify the originating application by identifying characteristics in the print job name is that the software applications installed on different clients 161 vary from job-processing apparatus to job-processing apparatus. Accordingly, it is not easy to provide a complete database of possible print job names. In view of this, the monitoring print server software 1622 includes a configurable job identification service that allows a user to specify the relationship between originating applications and the job names received at the monitoring print server software. If the names of all the print jobs printed are recorded by the monitoring print server software 1622 then the job identification service may be configured before or after the print audit period. An advantage of configuring the job identification service after the print audit period is that by examining a list of jobs printed during the audit period, it is possible to identify the client applications that have most often been used to print and to configure the job identification service for those client applications. In many cases it will be unnecessary to configure the job identification service for software applications that are only occasionally used to print on the job-processing apparatus 16.

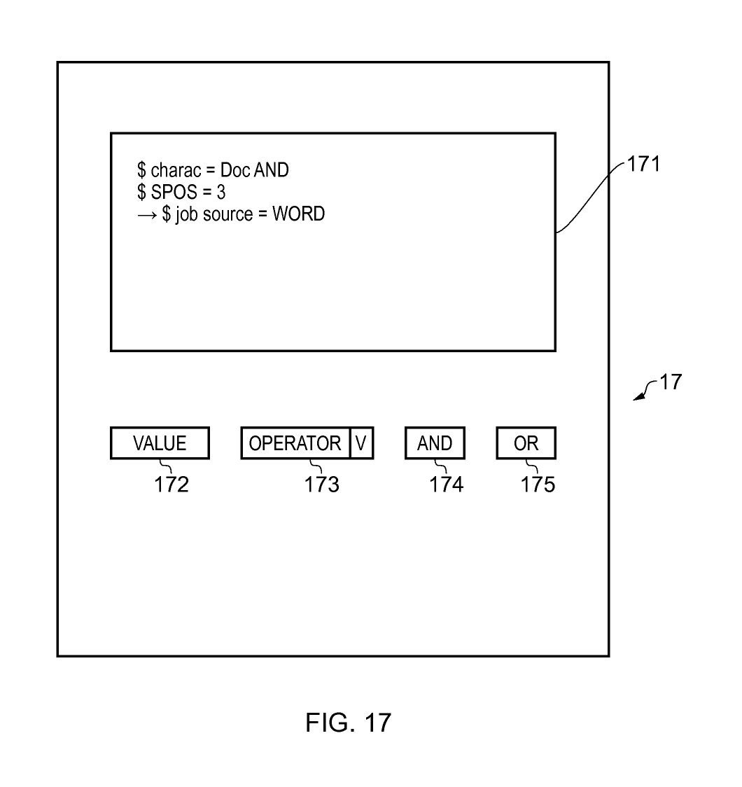

FIG. 17 shows a screen 17 for configuring the job identification service. The screen includes a script display area 171 for displaying and entering a user-configured script, a text-entry area 172 for entering values (in this illustrative example, “DOC” or “3”), an operator drop-down. menu 173 for selecting an operator (in this illustrative example “$charac” or “$spos”), a button 174 for entering a logical AND, and a button 175 for entering a logical OR. The script shown in FIG. 17 is for illustrative purposes only and represents a script that looks for the letters ‘doc’ starting at the third position in a job name. If the letters ‘doc’ are found at that starting position the script concludes that the source application for the job is Word®. Of course other operators and logical values may be provided to allow configuration of various different types of logic that allow the job identification service to identify a source application for monitored print jobs.

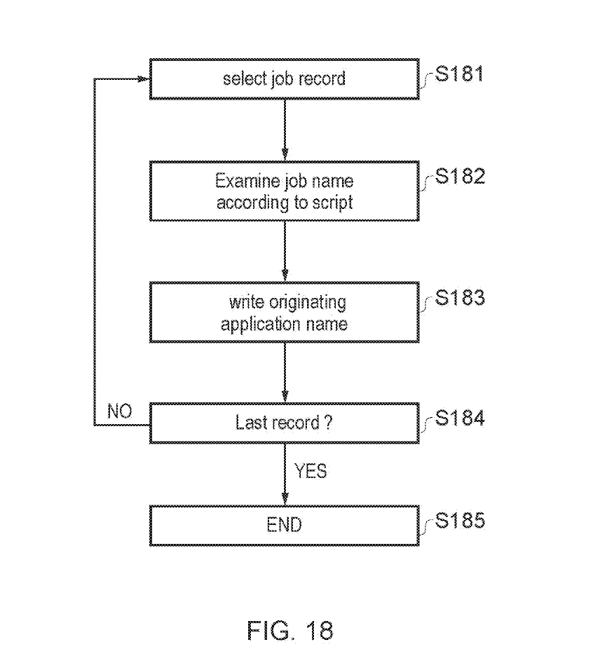

FIG. 18 is a flow chart showing the steps performed by the job identification service on a list of monitored print job records. In step S181, a print job is selected from the list of monitored print jobs. In step S182, the print job is examined according to the logic in the user configured script. In step S183, if a source application is identified for the selected print job by the script, the source application is added to the selected print job record. In step S184, the job identification service determines whether or not the selected record is the last record on the list of monitored print job records. If the record is the last record the process ends, otherwise the next print job record on the list of print job records is selected and the process is repeated.

As described above, printers are configured in the monitoring print server software 1622 based on detected spoolers on the print server 162 and possibly from other user specified remote print servers. However, in a job-processing apparatus 16 it is possible that a single physical printer 163 may be sent print jobs from more than one print spooler. This may happen where the same printer 1637 may be printed to from two different print servers, where two print queues are set up for the same printer which can receive print jobs in more than one page description language (PDL), or where multiple users print to the same printer directly from multiple clients 161. In these cases, for the purposes of validating the print data, it is useful to be able to combine the data from the multiple print queues (spoolers) so that print data for a physical printer 163 can be obtained. This problem is overcome in two parts. The first is that printer record configured in the monitoring print server software has a parameter field to contain additional spooler names. Thus, when a user is configuring a printer record using the printer configuration wizard the user may manually enter any additional spooler names for the printer so that multiple spoolers are monitored in connection with d single printer record.

The second part of combining the print data from different spoolers is via a consolidate physical printers task. The consolidate physical printers task analyses all the configured printers to find those configured printers that correspond to the same physical printer. The task is configurable by a user to determine whether or not the configured printers correspond to the same physical printer in the following ways:
a. configured printers relate to the same physical printer if they have the same Mac address;
b. configured printers relate to the same physical printer if they have the same Mac address and the same IP address; or
c. configured printers relate to the same physical printer if they have the same serial number.

When the task finds two or more printer records that correspond to the same physical printer it merges the print data into a single printer record. The task may then delete the redundant configured printer record in the monitoring print server software 1622.

Once print data has been collected at the end of the print audit period the recorded data needs to be finalized and reported. The monitoring print server software includes a data manipulation tool for adding additional information about printing and preparing reports. Such additional information may include, for example, information about the number of copies made at a printer 163, which cannot be obtained by spooler monitoring because the print job does not pass through a print queue. Such in may be obtained taking meter readings of the printers 163 at the start and end of the audit period. The data manipulation tool also includes a utility for generation of charts and reports which indicate various data such as total print volume, current utilization of existing printers 163, cost of printing, etc.

In a further embodiment of the present invention, the job identification service described in the second embodiment is adapted for use in the first embodiment. In this further embodiment, instead of identifying a source application for a list of monitored print job records, the job identification service identifies the source application for each print job at the time that it is received at the print server software. The workflow designer can then be used to configure a workflow using the source application as a parameter. For example, a workflow could be designed in which all print jobs from a particular source application are re-routed to a particular printer. This can be implemented, for example, so that all print jobs from an email application are sent to a low cost MFP for printing.

Embodiments of the present invention have been described above. Further embodiments of the present invention can also be realized by a job-processing apparatus for devices such as a CPU or MPU inside the job-processing apparatus) that reads out and executes a program recorded on a memory device to perform the functions of the above-described embodiment(s), and by a method, the steps of which are performed by, for example, reading out and executing a program recorded on a memory device to perform the functions of the above-described embodiment(s). For this purpose, the program may be provided to the job-processing apparatus for example via a network or from a recording medium of various types serving as the memory device (e.g., computer-readable medium).

1. A job-processing method for routing a print job to one of a plurality of printers in a job-processing apparatus, each of which printers has a low-power state, and a powered-up state, the method comprising:
determining a destination printer from print data included in the print job;
determining whether or not the destination printer is in the low-power state;
if the destination printer is in the low-power state, selecting at least one alternative printer;
determining the state of the at least one alternative printer; and
if the alternative printer is in the powered-up state, re-routing the print job from the destination printer to the alternative printer for printing.

2. A job-processing method according to claim 1, wherein the job-processing method is carried out in the job-processing apparatus during user configured time periods.

3. A job-processing method according to claim 1, wherein the alternative printer is selected based on whether or not it is a member of a group of printers to which the destination printer belongs.

4. A job-processing method according to claim 3, wherein the group of printers corresponds to at least one of: a group of printers that are geographically proximate to each other, a group of printers that either can or cannot print in colour, a group of printers with a similar per page printing cost, and a group of printers that have similar power consumption and/or ink-usage characteristics.

5. A job-processing method according to claim 1, further comprising the step of requesting permission from a source of the print job to re-route the print job before rerouting the print job to the alternative printer.

6. A job-processing apparatus according to claim 1 wherein the low-power state is a sleep state.

7. A job-processing apparatus according to claim 1 wherein the powered-up state is a busy state or an idle state.

8. A job-processing apparatus in communication with a plurality of printers, each of the printers has a low-power state, and a powered-up state, the apparatus comprising:
a processor for:
determining a destination printer from print data included in a print job to be printed in the job-processing apparatus;
determining whether or not the destination printer is in the low-power state;
if the destination printer is in the low-power state, selecting at least one alternative printer;
determining the state of the at least one alternative printer; and
if the alternative printer is in the powered-up state, causing the print job to be re-routed from the destination printer to the alternative printer for printing.

9. (canceled)

10. A non-transitory computer-readable storage medium storing a program executable by a job-processing apparatus having a plurality of printers, each of the printers having a low-power state and a powered-up state, the program when executed causing the job-processing apparatus to:
determine a destination printer from print data included in a print job to be printed in the job-processing apparatus;
determine whether or not the destination printer is in the low-power state;
select at least one alternative printer if the destination printer is in the low-power state;
determine the state of the at least one alternative printer; and
if the alternative printer is in the powered-up state, re-routing the print job from the destination printer to the alternative printer for printing.
